(19) United States
(12) Patent Application Publication
(10) Pub. No.: US 2006/0123656 A1
(43) Pub. Date: Jun. 15, 2006

(54) Method and apparatus for de-watering articles

(75) Inventor: Clifford H. B. Beck, Fox Lane (GB)

Correspondence Address: IPSOLON LLP, 111 SW COLUMBIA, SUITE 710, PORTLAND, OR, 97201, US

(73) Assignee: Secomak Ltd., Stanmore, Middlesex, ENG (GB)

(21) Appl. No.: 10/517,516

(22) PCT Filed: Apr. 24, 2003
(86) PCT No.: PCT/GB03/01743

§ 371 Date: Oct. 30, 2005

(30) Foreign Application Priority Data
May 8, 2002 (GB) 0210523.7

(51) Int. Cl. F26B 13/30; F26B 3/00

(52) U.S. Cl. 34/443; 34/92

(57) ABSTRACT

A method of de-watering an article (3) subjected to processing, such as pasteurising, in which water collects in a depression in a surface (2) of the article, comprises passing the article beneath a suction device (4) so that the said surface of the article passes underneath the suction device in proximity to an inlet (6) of the suction device, directing at last one jet of compressed air through a nozzle (10) at the depressed surface of the article as the said surface passes by the inlet of the suction device to displace the water from the said surface of the article into the air adjacent to the inlet of the suction device, and operating the suction device to draw the water-containing air into the inlet of the suction device. An apparatus for carrying out the de-watering method employs a Coanda effect air moving device as the suction device (4) and one or more air jet nozzles located at the inlet opening of the air moving device.

This invention relates to a method and apparatus for de-watering articles, i.e. removing moisture from the surface of articles which are subjected to processing involving the use of a liquid, such as water. In particular, the invention concerns a method and apparatus for de-watering articles which have a surface on which the process liquid collects.

The invention finds particular application in the case of containers, such as cans, which have a top or bottom end surface which is so shaped as to form a depression in which process water can collect when the cans are subjected to processing whilst in a standing position. When used to contain food or drink, cans are usually subjected to a pasteurising process after they have been filled. This pasteurising process commonly involves passing the cans, standing on end, through a heated oven on a conveyor belt. Moisture collects on the cans and, in particular, in the depression in whichever of the top or bottom end of the cans is uppermost.

In order to dry the pasteurised cans in preparation for packing and storage, the cans emerging from the pasteurising oven then pass through a de-watering stage which is intended to remove water from the surface of the cans, including the top or bottom end surfaces. At present, this water removal process is usually carried out by directing wide but thin streams of blown or compressed air at the surface of the cans. This known de-watering stage is however, not very effective in removing water from the recessed ends of the cans. Moreover, the de-watering apparatus is extremely cumbersome and noisy in operation and the water dislodged from the cans is simply blown into the surrounding air and onto surrounding surfaces. This renders the working environment of the canning operation very unpleasant and can disperse biological hazards into the atmosphere. Finally, the known de-watering apparatus is not energy efficient.

The present invention aims to provide a de-watering method and apparatus which overcomes at least some of these disadvantages of the known process and apparatus.

Accordingly, in a first aspect, the invention provides a method of de-watering an article subjected to processing in which a liquid, such as water, collects on a surface of the article, which method comprises conveying the article past a suction device so that the said surface of the article passes adjacent to an inlet of the suction device, directing at least one jet of air at the said surface of the article as the said surface passes by the inlet of the suction device to displace liquid from the said surface of the article into the surrounding air, and operating the suction device to draw the liquid-containing air into the inlet of the suction device.

In one embodiment, the method comprises directing a jet of air at the said surface of the article through a nozzle positioned within the inlet of the suction device.

Conveniently, the method comprises delivering compressed air to the nozzle from a source of compressed air through a compressed air pipe extending within the suction device.

Advantageously, the method comprises detecting the presence of an article adjacent to the inlet of the suction device and directing a pulse of air at the said surface of the article in response to the detection of the article.

In another embodiment, the method comprises directing a plurality of jets of air at the said surface of the article through a plurality of nozzles distributed around the periphery of the inlet of the suction device.

Advantageously, the method comprises supplying compressed air to the plurality of nozzles from a chamber of the suction device which is connected to a source of compressed air.

In an exemplary embodiment of the invention, the method comprises conveying the articles beneath the inlet opening of the suction device.

In another aspect, the invention provides apparatus for de-watering an article subjected to processing in which a liquid, such as water, collects on a surface of the article, which apparatus comprises a suction device having an inlet, means for conveying the article past the suction device so that the said surface of the article passes adjacent to the inlet of the suction device, and means for directing at least one jet of air at the said surface of the article as the surface passes by the inlet of the suction device to displace liquid from the said surface of the article into the air adjacent the inlet of the suction device.

In one embodiment, the means for directing at least one jet of air at the said surface of the article comprises a nozzle located in the inlet opening of the suction device.

Preferably, the nozzle is centrally located within the inlet opening of the suction device.

Conveniently, the nozzle is connected to a supply of compressed air by a compressed air pipe extending within the suction device.

Advantageously, the apparatus comprises means for detecting the presence of an article adjacent to the inlet of the suction device and means for directing a pulse of air at the said surface of the article in response to the detection of the article by the detecting means.

In an exemplary embodiment of the apparatus according to the invention, the suction device is a Coanda effect air moving device.

In order that the invention may be more readily understood, an embodiment thereof will now be described, by way of example, with reference to the accompanying drawings, in which:

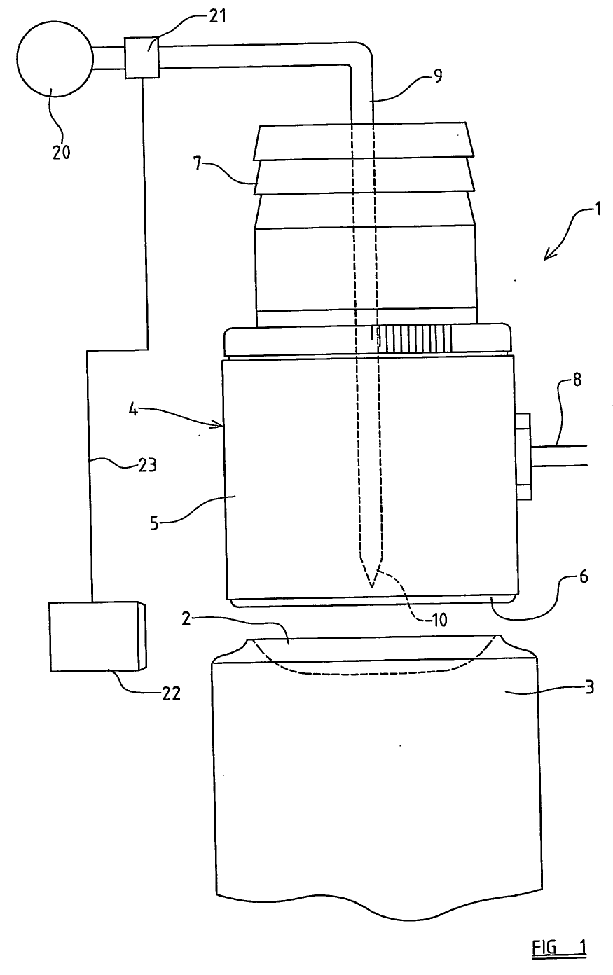

FIG. 1 is a schematic representation of one embodiment of a de-watering apparatus according to the present invention;

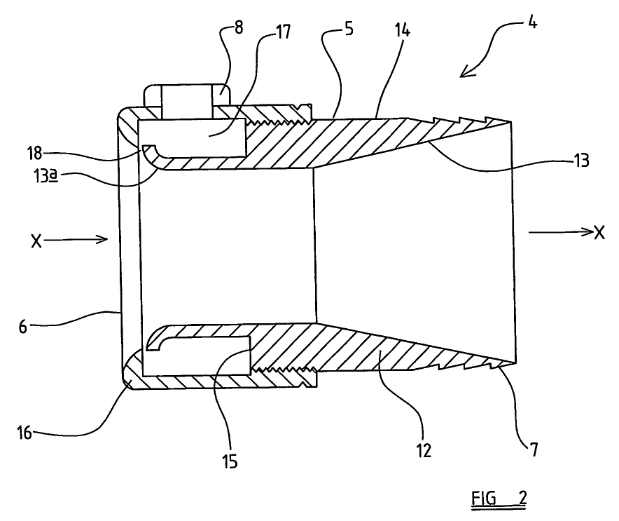

FIG. 2 is a schematic cross-sectional view of a suction device used in the de-watering apparatus of FIG. 1, illustrating the way in which the suction device operates;

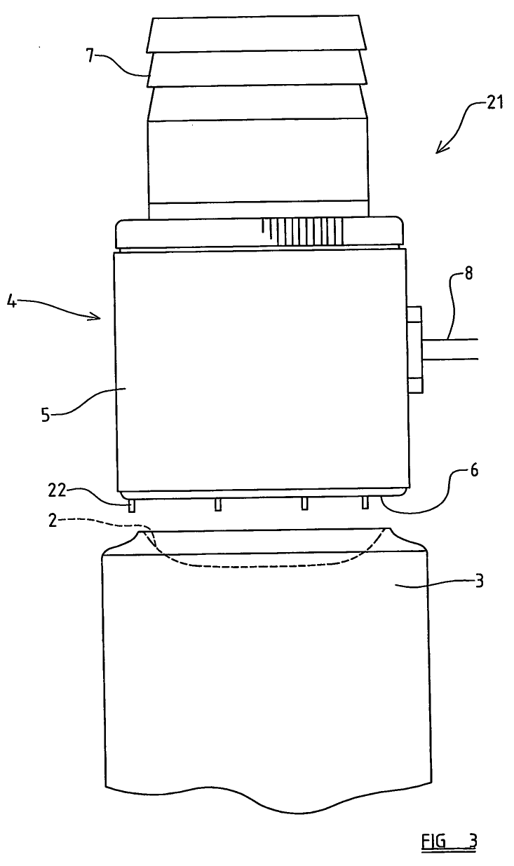

FIG. 3 is a schematic representation of another embodiment of a de-watering apparatus according to the present invention: and

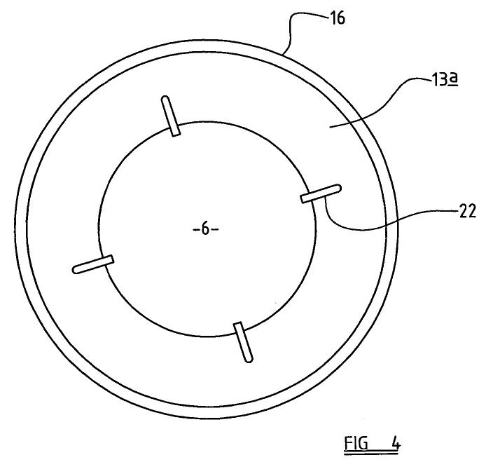

FIG. 4 is an end view of the apparatus of FIG. 3.

Referring initially to FIG. 1, a de-watering apparatus 1 embodying the present invention may be used, for example, to remove water collected in a depression 2 formed by the concave bottom end surface of an inverted food or drinks can 3 emerging from a heated oven (not shown) through which the can 3 has passed standing on a conveyor in order to pasteurise the contents of the can.

The de-watering apparatus comprises a suction device 4 which is positioned above a conveyor (not shown) on which the cans 3 are travelling after they emerge from the pasteurising oven. In the present embodiment, the suction device 4 comprises an air moving device which is based on the Coanda effect and which comprises a tubular body 5 having an inlet opening 6 at one end and a ribbed hose spigot 7 at the other end for connection to an outlet hose (not shown). The suction device 4 is operable to induce an air flow into the inlet opening 6 and through the body 5, in a manner to be described later with reference to FIG. 2, by compressed air supplied to the device through a compressed air connection 8 from a source of compressed air (not shown).

The body 5 is supported in a substantially vertical orientation, with its inlet opening 6 lowermost, by a support structure (not shown) which enables the height of the opening above the conveyor to be adjusted to suit cans of different sizes and to obtain maximum suction efficiency.

A compressed air pipe 9 extends through the body 5 of the suction device 4 and has a lower end which terminates in an air jet 10 located substantially at the level of the inlet opening 6 of the suction device 4. The upper end of the compressed air pipe 9 is located above the spigot 7 and is connected to a source of compressed air 20 via a valve 21 adapted to deliver pulses of compressed air to the air jet 10.

In use, the inlet opening 6 of the suction device 4 is positioned at a suitable location along the conveyor on which the cans 3 travel from the pasteurising oven, so that the cans 3 pass directly beneath the inlet opening 6 of the suction device 4, which inlet opening 6 is disposed at a height such that the concave bottom of each inverted can 3 is in close proximity to the inlet opening 6 as the can passes beneath the suction device 4.

The apparatus includes sensing means 22 which detects the presence of a can 3 as it arrives beneath the inlet opening 6 and operates the valve 21 via control line 23 to cause a pulse of compressed air to be supplied through the pipe 9 to the air jet 10 which thus directs a jet of air into the depression 2 in the bottom of the inverted can 3. Any water in the depression 2 is thereby blown into the air adjacent to the inlet opening 6 of the suction device 4 which operates to draw the water-containing air through the body 5, through the outlet hose and into a collecting vessel connected to the outlet hose.

As shown in more detail in FIG. 2, the body 5 of the suction device 4 comprises a main tube 12 having a venturi-like inner profile 13 with a curved portion 13a at the inlet 6 of the device 4. An outer profile 14 of the main tube 12 is formed at one end with the spigot 7. At its other end the main tube 12 is formed with a recessed portion 15 and is externally screw-threaded to receive an annular collar 16 which is formed with the compressed air connection 8 and defines with the recessed portion 15 an annular chamber 17 which has a narrow ring-shaped outlet aperture 18 opening into the interior of the main tube 12. Compressed air is fed into the chamber 15 through the compressed air connection and exits through the outlet opening 18. Due to the Coanda effect, the compressed air leaving the chamber 17 adheres to the curved inner profile 13a of the main tube 12 at the inlet 6 and, in passing along the inner profile 13, induces an accompanying airflow indicted by the arrows X from outside the device into the inlet opening 6 and through the main tube 12 into the outlet hose connected to the spigot 7.

In contrast to the known de-watering apparatus which uses streams of air simply to blow water from the end surfaces of the cans into the ambient air, the apparatus embodying the invention is quiet in operation, is energy efficient and provides a much more pleasant and healthy working environment in which the displaced water is removed from the ambient air and collected for subsequent disposal to a drain or re-circulation within the system.

FIGS. 3 AND 4 illustrate a second de-watering apparatus 21 embodying the invention, parts of this second embodiment which correspond to like parts of the first embodiment shown in FIGS. 1 and 2 being indicated by like reference numerals. Like the first embodiment, the second embodiment of the apparatus employs a Coanda effect suction device 4 having an inlet opening 6 beneath which a can to be de-watered is conveyed.

As shown in FIGS. 3 and 4, however, the second embodiment differs from the first in having a plurality of air jets, in the form of four micro jets 22 each having an internal diameter of 0.05 mm, equally spaced around the inlet opening 6 of the suction device 4 instead of a single air jet 9 centrally positioned in the inlet opening 6 as in the first embodiment.

The air jets 22 are mounted on, and extend through, the curved inlet surface 13A of the suction device 4, so that they communicate with the chamber 17 of the suction device 4 and are supplied with compressed air from the chamber 17. The air jets 30 are arranged so to project slightly from the inlet opening 6 and are angled slightly towards the central axis 12A of the main tube 12 so that they deliver slightly convergent streams of air directed away from the inlet opening 6 of the suction device 4. In operation, the outwardly directed air streams from the air jets 30 serve to displace water from the depression 2 of a can 3 arriving beneath the suction device 4 into the air adjacent the inlet opening 6 for removal by the suction device 4.

Since the air jets 30 of the second embodiment receive their compressed air supply directly from the suction device 4 itself, the air jets of the second embodiment do not require a separate compressed air supply like the pulsed air supply arrangement provided in the first embodiment for the air jet 9.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1-19. (canceled)

20. A method of de-watering an article subjected to processing in which a liquid, such as water, collects on a surface of the article, which method comprises:
conveying the article past a suction device so that the said surface of the article passes adjacent to an inlet of the suction device;
directing at least one jet of air at the said surface of the article as the said surface passes by the inlet of the suction device to displace liquid from the said surface of the article into the air adjacent to the inlet of the suction device; and operating the suction device to draw the liquid-containing air into the inlet of the suction device;
using a suction device comprising an air moving device which is based on the Coanda effect and which comprises a tubular body having an inlet opening at one end and an outlet connection at the other end; and
directing the or each jet of air at the surface of the article through a nozzle located in the inlet opening of the tubular body.

21. A method according to claim 20 comprising directing a jet of air at the surface of the article through a nozzle positioned centrally within the inlet opening of the tubular body.

22. A method according to claim 21 comprising delivering compressed air to the nozzle from a source of compressed air through a compressed air pipe extending within the suction device.

23. A method according to claim 20 comprising detecting the presence of an article adjacent to the inlet opening of the tubular body and directing a pulse of air at the said surface of the article in response to the detection of the article.

24. A method according to claim 20 comprising directing a plurality of jets of air at the said surface of the article through a plurality of nozzles distributed around the periphery of the inlet opening of the tubular body.

25. A method according to claim 24 comprising supplying compressed air to the plurality of nozzles from a chamber of the tubular body which is connected to a source of compressed air.

26. A method according to claim 20 comprising passing the articles beneath the inlet opening of the tubular body.

27. Apparatus for de-watering articles subjected to processing in which a liquid, such as water, collects on a surface of the article, comprising:
a suction device having an inlet;
means for conveying an article past the suction device so that the said surface of the article passes by the inlet of the suction device;
means for directing at least one jet of air at the said surface of the article as the surface passes by the inlet of the suction device to displace liquid from the said surface of the article into the air adjacent the inlet of the suction device;
wherein the suction device comprises an air moving device which is based on the Coanda effect and which comprises a tubular body having an inlet opening at one end and an outlet connection at the other end; and
the means for directing the or each jet of air at the said surface of the article comprises a nozzle located in the inlet opening of the tubular body.

28. Apparatus according to claim 27 wherein the means for directing the jet of air at the said surface of the article comprises a nozzle positioned centrally within the inlet opening of the tubular body.

29. Apparatus according to claim 27 wherein the nozzle is connected to a source of compressed air by a compressed air pipe extending within the suction device.

30. Apparatus according to claim 27 comprising means for detecting the presence of an article adjacent to the inlet opening of the tubular body and means for directing a pulse of air at the said surface of the article in response to the detection of the article by the detecting means.

31. Apparatus according to claim 27 wherein the means for directing the jet of air at the said surface of the article comprises a plurality of nozzles distributed around the inlet opening of the tubular body.

33. Apparatus according to claim 31 wherein the plurality of nozzles are equally spaced around the inlet opening of the tubular body.

34. Apparatus according to claim 31 wherein the plurality of nozzles are mounted on the tubular body and are supplied with pressurized air from a chamber of the tubular body which is connected to a source of compressed air.
